(19) United States
(12) Patent Application Publication
(10) Pub. No.: US 2018/0332673 A1
(43) Pub. Date: Nov. 15, 2018

(54) COOKER

(71) Applicant: Panasonic Intellectual Property Management Co., Ltd., Osaka (JP)

(72) Inventors: AKIRA KATAOKA, Shiga (JP); MASAKI SHIBUYA, Osaka (JP)

(21) Appl. No.: 15/775,862

(22) PCT Filed: Nov. 16, 2016
(86) PCT No.: PCT/JP2016/004895

§ 371 Date: May 14, 2018

(30) Foreign Application Priority Data
Dec. 16, 2015 (JP) 2015-244776

(51) Int. Cl. H05B 6/64; H05B 6/68

(52) U.S. Cl. CPC H05B 6/6479; H05B 6/687

(57) ABSTRACT

The steam generating device includes temperature increasing unit that turns water into steam, heat source that supplies heat to temperature increasing unit, and water storage unit that has a recess below temperature increasing unit. Temperature increasing unit of steam generating device is preheated to a predetermined temperature, and water stored in water storage unit contacts with temperature increasing unit. According to this configuration, a large volume of steam can be instantaneously generated, and scale adhesion can be reduced because a scale component dissolves in the water in water storage unit.

### TECHNICAL FIELD

The present invention relates to a cooker that can speedily heat a food item by using steam.

### BACKGROUND ART

Conventionally, a steam cooker and a heating cooker that include a steam generating device and cook a food item by using steam are proposed (see, for example, Patent Literature 1 and Patent Literature 2).

### CITATION LIST

### Patent Literature

PTL 1: Unexamined Japanese Patent Publication No. H8-105628

PTL 2: Unexamined Japanese Patent Publication No. 2007-17073

### SUMMARY OF THE INVENTION

A steam generating device of a conventional steam cooker disclosed in Patent Literature 1 generates steam speedily by dropping water from above a heat generator. However, this method has a problem that in a case where the dropped water contains a scale component, the scale component precipitates and adheres onto a top surface of the heat generator when the water evaporates.

Meanwhile, a steam generating device of a conventional heating cooker disclosed in Patent Literature 2 generates steam by putting a predetermined amount of water into a pot, energizing a steam generating heater that is provided in the pot, and thereby boiling the water. This method has a problem that it takes time to generate steam.

The present invention provides a cooker that generates steam speedily and heats a food item or the like by using the generated steam and the like while reducing adhesion of scale component on a steam generating device.

A cooker according to the present invention includes a steam generating device that supplies steam to a cooker, a water supply device that supplies water to the steam generating device, and a control device that controls at least the steam generating device and water supply device. Furthermore, the steam generating device includes a temperature increasing unit that turns water into steam, a heat source that supplies heat to the temperature increasing unit, and a water storage unit that has a recess below the temperature increasing unit, and steam is generated by contact of water stored in the water storage unit with the temperature increasing unit.

According to this configuration, steam can be speedily generated since steam is instantaneously generated when the water in the water storage unit makes contact with the temperature increasing unit. Furthermore, only water that makes contact with the temperature increasing unit, i.e., only topmost water in the water storage unit evaporates even in a case where a scale component is contained in water in the water storage unit. Accordingly, when a scale is generated during evaporation, the scale component dissolves into water that is not directly involved in evaporation. As a result, it is possible to reduce precipitation and adhesion of a scale on the steam generating device.

As described above, the present invention can provide a cooker that can heat a food item by generating steam speedily and reduce precipitation and adhesion of a scale on a steam generating device and that is easy to use and excellent in reduction of scale adhesion.

### BRIEF DESCRIPTION OF DRAWINGS

FIG. 1 is a front view of a cooker according to a first exemplary embodiment of the present invention.

FIG. 2 is a detailed view of an operation unit of the cooker according to the first exemplary embodiment of the present invention.

FIG. 3 is a cross-sectional view of an overall configuration of the cooker according to the first exemplary embodiment of the present invention.

FIG. 4 is a cross-sectional view of a substantial part of a steam generating device of the cooker according to the first exemplary embodiment of the present invention.

FIG. 5 is a plan view of an upper part of the steam generating device of the cooker according to the first exemplary embodiment of the present invention viewed from a bottom side.

FIG. 6 is a plan view of a lower part of the steam generating device of the cooker according to the first exemplary embodiment of the present invention viewed from a top side.

FIG. 7 is a detailed view of “preheating” displayed on an operation unit of the cooker according to the first exemplary embodiment of the present invention.

FIG. 8 is a flowchart showing contents of control of preheating of the cooker according to the first exemplary embodiment of the present invention.

FIG. 9 is a flowchart showing contents of control of heating of the cooker according to the first exemplary embodiment of the present invention.

FIG. 10 is a detailed view of information on heating displayed on the operation unit of the cooker according to the first exemplary embodiment of the present invention.

FIG. 11 is a timing chart illustrating a water supply pattern of the cooker according to the first exemplary embodiment of the present invention.

FIG. 12 is a cross-sectional view of a substantial part of another example of a steam generating device of the cooker according to the first exemplary embodiment of the present invention.

FIG. 13 is a cross-sectional view of a substantial part of a cooker according to a second exemplary embodiment of the present invention.

FIG. 14 is a cross-sectional view of a substantial part of a food item container body of the cooker according to the second exemplary embodiment of the present invention viewed from above.

FIG. 15 is a cross-sectional view of a substantial part of a steam chamber of the cooker according to the second exemplary embodiment of the present invention viewed from above.

FIG. 16 is a cross-sectional view of an overall configuration of a cooker according to a third exemplary embodiment of the present invention.

FIG. 17 is a flowchart showing contents of control of heating of the cooker according to the third exemplary embodiment of the present invention.

FIG. 18 is a detailed view of information on heating displayed on an operation unit of the cooker according to the third exemplary embodiment of the present invention.

FIG. 19 is a timing chart illustrating a water supply pattern of the cooker according to the third exemplary embodiment of the present invention.

### DESCRIPTION OF EMBODIMENTS

Hereinafter, exemplary embodiments of the present invention will be described with reference to the drawings. The present invention is not limited to the exemplary embodiments.

### First Exemplary Embodiment

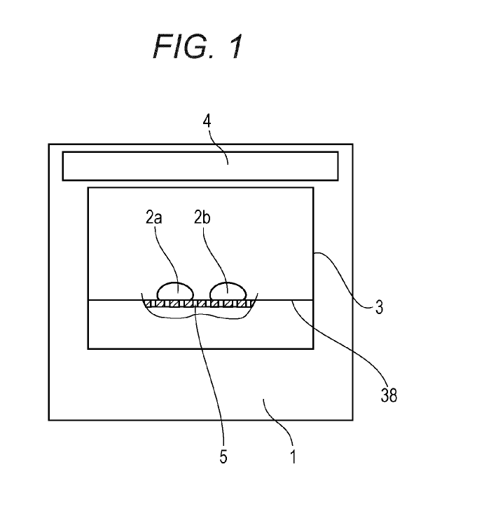

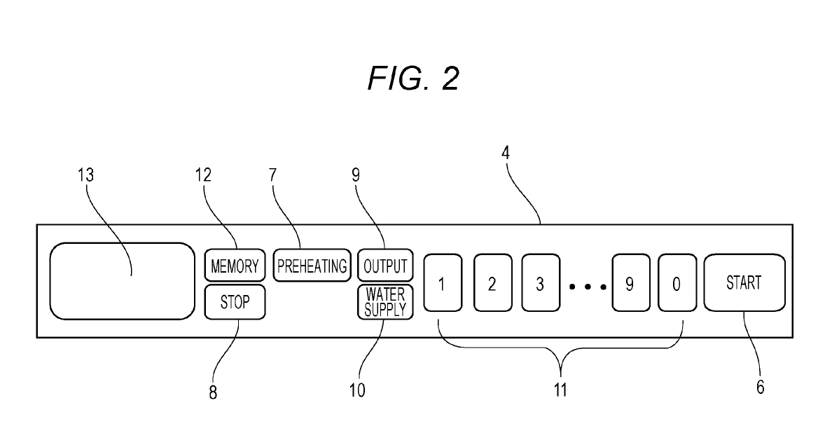

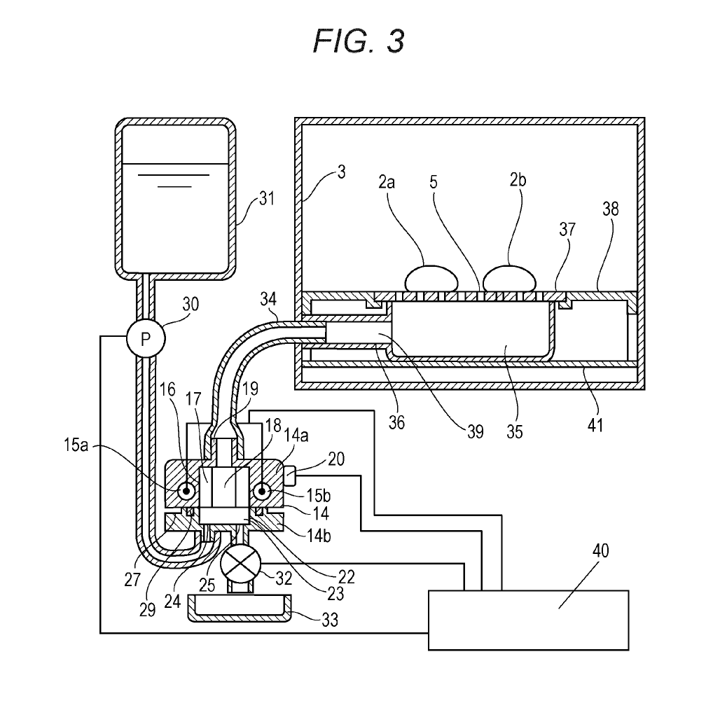

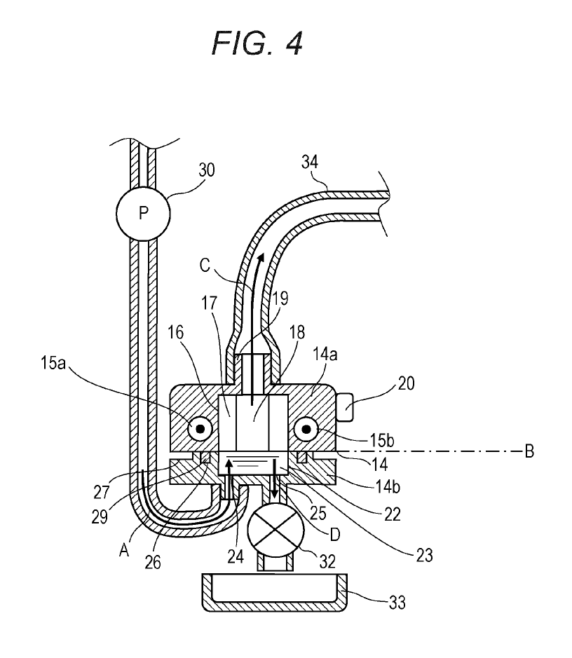

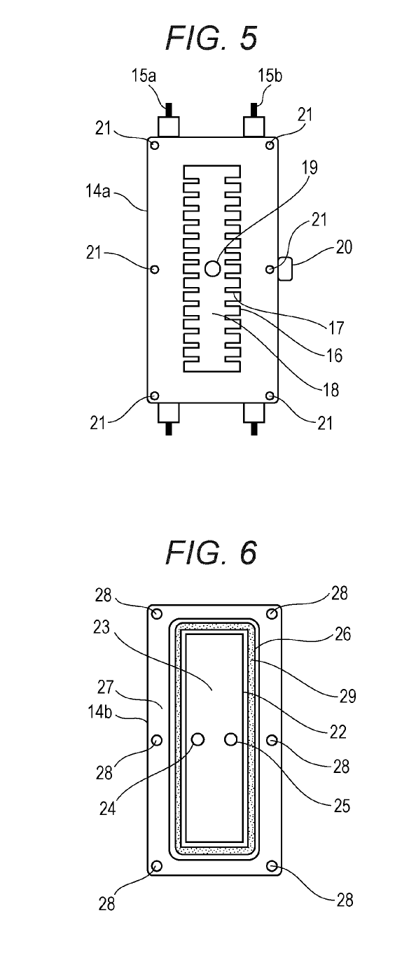

FIG. 1 is a front view of a cooker according to a first exemplary embodiment of the present invention. FIG. 2 is a detailed view of an operation unit of the cooker according to the first exemplary embodiment of the present invention. FIG. 3 is a cross-sectional view of an overall configuration of the cooker according to the first exemplary embodiment of the present invention. FIG. 4 is a cross-sectional view of a substantial part of a steam generating device of the cooker according to the first exemplary embodiment of the present invention. FIG. 5 is a plan view of an upper part of the steam generating device of the cooker according to the first exemplary embodiment of the present invention viewed from a bottom side. FIG. 6 is a plan view of a lower part of the steam generating device of the cooker according to the first exemplary embodiment of the present invention viewed from a top side.

As illustrated in FIGS. 1 to 6, cooking chamber 3 in which an item to be heated, for example, food items 2a and 2b such as frozen meat buns are contained is provided in body 1 of the cooker, and operation unit 4 is provided on an upper part of body 1. A door (not illustrated) is provided on a front face of cooking chamber 3, and the door is pulled so as to be rotationally moved when the front face of cooking chamber 3 is opened. Food items 2a and 2b are placed on placing table 38 provided in cooking chamber 3. Placing table 38 has a plurality of steam ejection openings 5 that are small holes.

As illustrated in FIG. 2, operation unit 4 includes start key 6 that is operated to start heating, preheating key 7 for setting whether or not to perform preheating, stop key 8 that is operated to stop heating, and output key 9 for selecting a heating state. Furthermore, operation unit 4 includes water supply key 10 for selecting a state of water supply or water drainage, a plurality of numeric keys 11 used to enter a heating period and the like, memory key 12 used to memorize a heating state, and display 13, such as a liquid crystal display, on which various states are displayed. Steam generating device 14 illustrated in FIGS. 3 and 4 is provided in body 1. Upper part 14a of steam generating device 14 is made, for example, of die-cast aluminum and includes heat sources 15a and 15b that are sheath heaters, and temperature increasing unit 16 is provided on an inner side of heat sources 15a and 15b. Walls of temperature increasing unit 16 have fin-shaped projections 17 (see FIG. 5). A space surrounded by the walls of temperature increasing unit 16 serves as steam generating chamber 18. Steam generating chamber 18 has steam hole 19 in an upper surface. Temperature detector 20 is provided on an outer wall side close to temperature increasing unit 16 and detects a temperature of temperature increasing unit 16. Upper part 14a of steam generating device 14 has screw holes 21 at peripheral parts of a bottom surface (see FIG. 5).

Lower part 14b of steam generating device 14 is made, for example, of die-cast aluminum and forms water storage unit 23 having recess 22 (see FIG. 6). Water supply hole 24 and water drainage hole 25 are provided in a bottom surface of water storage unit 23. An upper surface of lower part 14b of steam generating device 14 has packing groove 26 and step 27. Through holes 28 are provided at peripheral parts of step 27 (see FIG. 6).

Ring-shaped packing 29 that is attached to packing groove 26 and is made, for example, of silicone rubber is provided between upper part 14a and lower part 14b of steam generating device 14. This prevents leakage of steam. Upper part 14a and lower part 14b of steam generating device 14 are fixed to each other, for example, by inserting screws (not illustrated) into through holes 28 provided in lower part 14b and fastening the screws in screw holes 21 formed in upper part 14a.

As illustrated in FIG. 3, water supply device 30 that is an electric pump supplies water from water supply tank 31 provided in body 1 to water supply hole 24. Water drainage from water drainage hole 25 that is communicated with water storage unit 23 is controlled by opening and closing of electric drain valve 32. Drained water is received by water drainage tray 33. One end of relay tube 34 that is made, for example, of silicone rubber is attached to steam hole 19, and the other end of relay tube 34 is attached to a side wall of cooking chamber 3.

Placing table 38 of cooking chamber 3 holds apertured plate 37 at a center, and steam chamber 35 is provided below apertured plate 37. Steam chamber 35 has steam introducing path 36 that is fitted with relay tube 34 put into cooking chamber 3. Steam chamber 35, apertured plate 37, and placing table 38 are made, for example, of a polypropylene resin that can endure a temperature of steam and the like. Relay tube 34 and steam chamber 35 constitute communicating path 39, and steam generated in steam generating chamber 18 is delivered to steam ejection openings 5 formed in apertured plate 37 through communicating path 39.

Control device 40 illustrated in FIG. 3 is electrically connected to heat sources 15a and 15b, temperature detector 20, water supply device 30, and drain valve 32 and controls a series of operations. Cooking chamber bottom plate 41 fixed close to an inner side of a bottom of cooking chamber 3 is made, for example, of heat-resistant glass such as crystallized glass, and steam chamber 35 and placing table 38 can be placed on cooking chamber bottom plate 41.

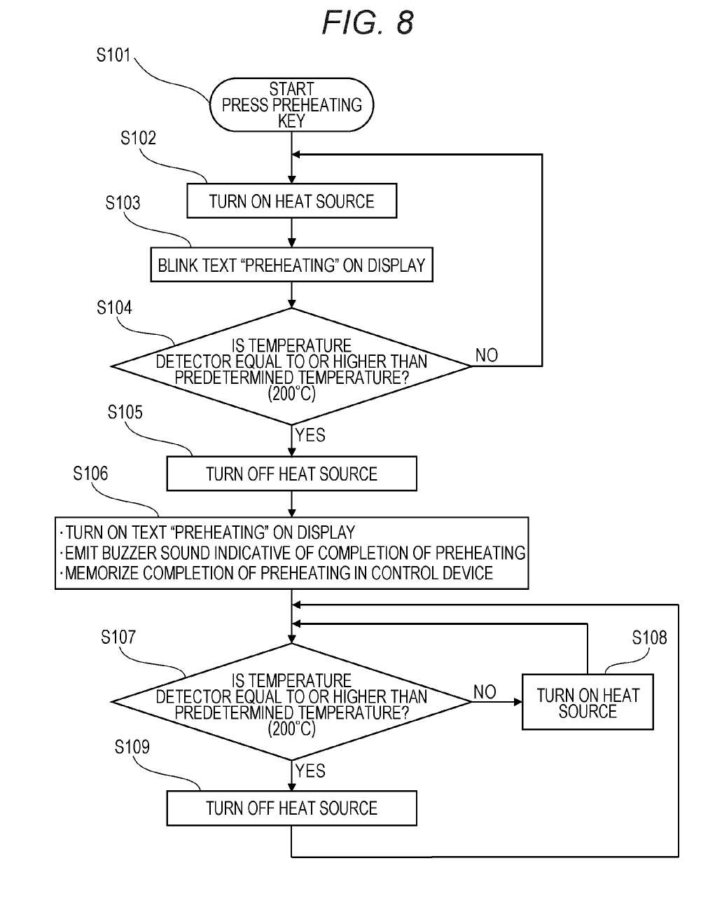

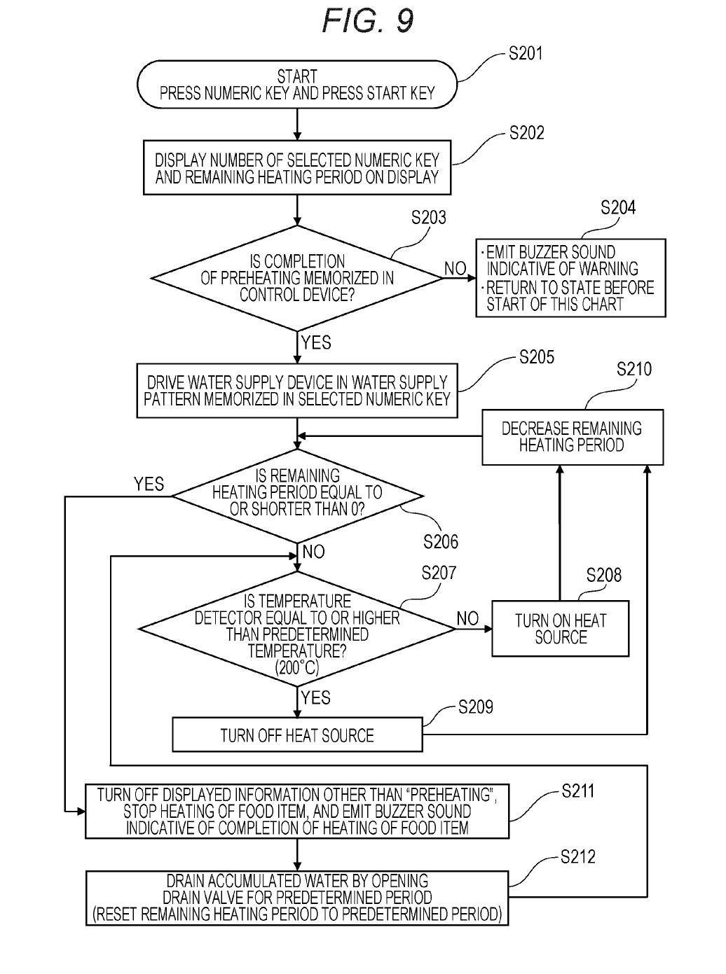

Hereinafter, the manner of operation and effects of the cooker having the above-mentioned configuration will be described with reference to the flowcharts in FIGS. 8 and 9.

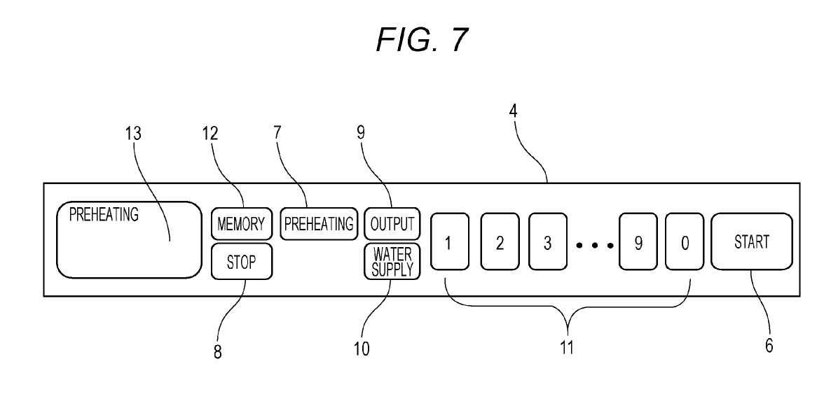

When preheating key 7 of operation unit 4 is pressed (step S101 of FIG. 8), control device 40 starts energizing heat sources 15a and 15b (step S102) and displays a text “preheating” on display 13 as illustrated in FIG. 7 and blinks the text “preheating” (step S103). Then, control device 40 energizes heat sources 15a and 15b until a temperature of temperature increasing unit 16 of steam generating device 14 that is being detected by temperature detector 20 reaches a predetermined temperature (set to 200° C. in the present exemplary embodiment) (step S104).

When the temperature detected by temperature detector 20 reaches the predetermined temperature (step S104), control device 40 stops energization of heat sources 15a and 15b once (step S105). Furthermore, control device 40 memorizes completion of preheating and changes the blinking state of the text “preheating” displayed on display 13 to an ON state and notifies a user about completion of preheating by issuing buzzer sound indicative of completion (step S106). Furthermore, when the temperature detected by temperature detector 20 decreases to a temperature lower than the predetermined temperature (step S107), control device 40 starts energizing heat sources 15a and 15b (step S108), and when the temperature detected by temperature detector 20 reaches the predetermined temperature (step S107), control device 40 stops energization of heat sources 15a and 15b once (step S109). In this way, control device 40 repeats stoppage and start of energization. Accordingly, the temperature of temperature increasing unit 16 is kept close to the predetermined temperature.

In this state, the door (not illustrated) of cooking chamber 3 is opened, food items 2a and 2b are placed above steam ejection openings 5 of apertured plate 37 as illustrated in FIG. 3, numeric key 11 memorizing a heating pattern suitable for heating of food items 2a and 2b in advance is pressed, and start key 6 is pressed (step 5201 of FIG. 9). In this way, food items 2a and 2b are heated.

In the present exemplary embodiment, food items 2a and 2b are frozen meat buns, and therefore numeric key 11 given a number “1” memorizing a heating pattern suitable for a frozen meat bun is pressed. This heating is performed on the assumption that preheating of temperature increasing unit 16 has been completed. For this reason, in a case where preheating has not been completed, i.e., in a case where completion of preheating is not memorized in control device 40 (step S203), the operation does not proceed even if start key 6 is pressed, and buzzer sound indicative of warning is issued to alert the user (step S204). In a case where a user wants to memorize a heating pattern in numeric key 11 in advance, the heating pattern is memorized according to a predetermined algorithm by using memory key 12, output key 9, water supply key 10, numeric key 11, and the like.

In a state where preheating of temperature increasing unit 16 of steam generating device 14 has been completed, numeric key 11 (number “1” in the present exemplary embodiment) for a heating pattern suitable for food items 2a and 2b is pressed as described above, and start key 6 is pressed (step S201).

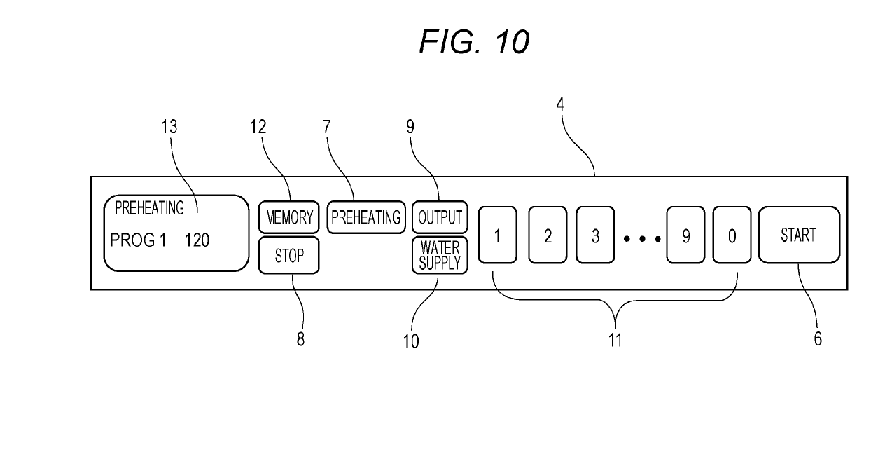

As a result, “PROG 1” indicative of which heating pattern is being used and “120” indicative of remaining seconds of heating are displayed on display 13 in addition to the text “preheating” as illustrated in FIG. 10 (step S202).

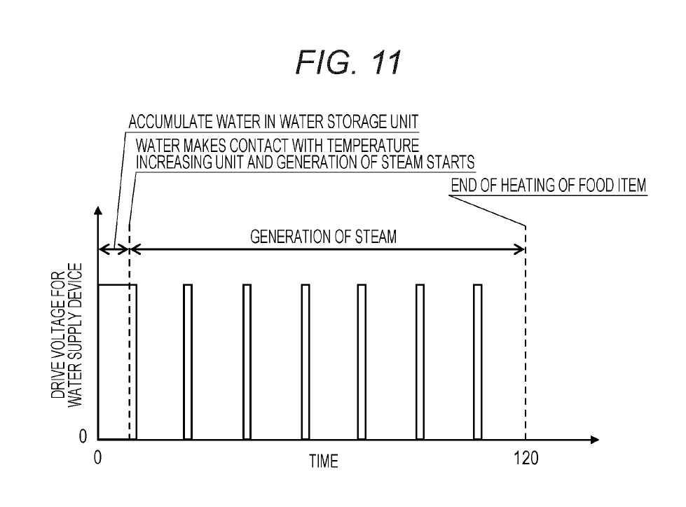

Concurrently, water supply suitable for food items 2a and 2b is performed. Specifically, water supply device 30 that is an electric pump is driven in a predetermined water supply pattern (see FIG. 11) corresponding to the heating pattern of numeric key 11 selected by control device 40, and thus water is delivered to water storage unit 23 as indicated by arrow A in FIG. 4 from water supply tank 31 (see FIG. 3) through water supply hole 24 (step S205).

As illustrated in FIG. 11, in this water supply, an amount of water to be stored in water storage unit 23 is first supplied. When water contacts with temperature increasing unit 16 and generation of steam starts, a predetermined amount of water (an amount of water is controlled by repetition of ON and OFF of water supply device 30 in the present exemplary embodiment) is supplied, and thus steam is stably generated.

Accordingly, supplied water is accumulated in recess 22 of water storage unit 23, and a water level gradually rises. When the water level exceeds a point indicated by alternate long and short dash line B in FIG. 4, water touches temperature increasing unit 16 and fin-shaped projections 17. Since temperature increasing unit 16 is preheated to the predetermined temperature (approximately 200° C.), water that contacts with temperature increasing unit 16 and fin-shaped projections 17 instantaneously turns into steam, and steam generating chamber 18 is filled with steam. A pressure of accumulated steam causes the steam to rush through relay tube 34 from steam hole 19 as indicated by arrow C, be ejected from steam ejection openings 5 through steam chamber 35, and then make contact with food items 2a and 2b.

In this way, a large volume of heat accumulated in temperature increasing unit 16 by preheating is transmitted to steam, and thus the large volume of heat can be transmitted to food items 2a and 2b. This makes it possible to promote heating of food items 2a and 2b at once. Water that drops, for example, from food items 2a and 2b is drained to steam chamber 35 through steam ejection openings 5. This can make food items 2a and 2b less damp, thereby improving a finished state of food items 2a and 2b.

Furthermore, even in a case where water in water storage unit 23 contains a scale component, only water that makes contact with (touches) a lower part of temperature increasing unit 16, i.e., only topmost water in water storage unit 23 evaporates. Accordingly, even if a scale is generated during evaporation, the scale component dissolves into water that is not directly related to evaporation. It is therefore possible to suppress precipitation of a scale on temperature increasing unit 16 and the like in steam generating device 14.

The remaining heating time (“120” in FIG. 9) displayed on display 13 decreases with passage of a heating time (steps S206 to S210), and the user is notified of completion of heating of food items 2a and 2b when the displayed remaining heating time becomes “0” (step S206). As a method for notifying the user, “PROG 1” and the remaining heating time are turned off (step S211). Furthermore, buzzer sound indicative of completion of heating of food items 2a and 2b is emitted (step S211).

Even after completion of food item heating, temperature increasing unit 16 of steam generating device 14 keeps preheating at the predetermined temperature (approximately 200° C.) by resetting the remaining heating time to a predetermined period (a period for which preheating is continued) (step S212) as illustrated in the flowchart of FIG. 9 and thus prepares for heating of a next food item. In a case where the user wants to finish preheating, the user presses preheating key 7 of operation unit 4 and presses the stop key promptly (within two seconds). As a result, the text “preheating” on display 13 disappears, and thus preheating can be stopped. As described above, when heating of food items 2a and 2b ends, control device 40 opens drain valve 32, and thus water accumulated in water storage unit 23 during heating is drained (step S212). As illustrated in the flowchart of FIG. 9, drain valve 32 is opened only for a predetermined period after the end of heating of food items 2a and 2b, and drain valve 32 is closed for a period other than the predetermined period. In a case where used water contains a scale component, the scale component is condensed in accumulated water. By draining the accumulated water as indicated by arrow D in FIG. 4, it is possible to suppress accumulation of a scale in steam generating device 14.

Upper part 14a and lower part 14b of steam generating device 14 according to the present exemplary embodiment are separate from each other, and a gap between upper part 14a and lower part 14b is sealed by packing 29. In this way, leakage of water and steam in steam generating device 14 is prevented.

Furthermore, since upper part 14a and lower part 14b of steam generating device 14 are separate from each other, it is possible to suppress heat transfer from temperature increasing unit 16 in upper part 14a to water storage unit 23 in lower part 14b. Furthermore, in the present exemplary embodiment, step 27 is provided on the upper surface of lower part 14b, and heat transfer from temperature increasing unit 16 to water storage unit 23 is reduced by a space created by step 27. This makes it possible to suppress a rise in temperature of lower part 14b even in a case where temperature increasing unit 16 is always preheated. It is therefore possible to suppress occurrence of a situation where the temperature of water storage unit 23 rises, water evaporates just because the water is supplied to water storage unit 23, and a scale precipitates on water storage unit 23.

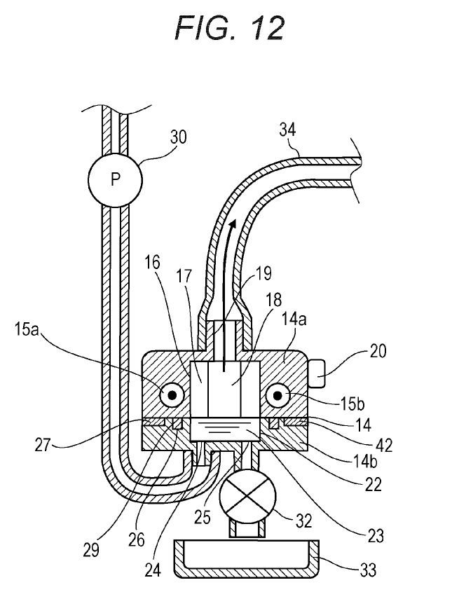

In a case where heat insulating material 42 such as mica is provided on step 27 as illustrated in FIG. 12, heat transfer from upper part 14a to lower part 14b of steam generating device 14 is more stably suppressed, and thus a rise in temperature of water storage unit 23 can be reduced. By thus enhancing suppression of heat transfer, a material for lower part 14b of steam generating device 14 can be changed from die-cast aluminum to a heat-resistant resin (e.g., polyphenylene sulfide) or the like. By changing the material to a heat-resistant resin having lower heat conductivity than die-cast aluminum, heat transfer to water storage unit 23 is further reduced.

Furthermore, since upper part 14a and lower part 14b of steam generating device 14 are separate from each other, productivity of steam generating device 14 can be improved markedly. Upper part 14a of steam generating device 14 has fin-shaped projections 17 and steam hole 19, and lower part 14b of steam generating device 14 has recess 22, water supply hole 24, water drainage hole 25, and the like. That is, shapes of upper part 14a and lower part 14b are complicated. A reason why molding of upper part 14a and lower part 14b is relatively easy regardless of the complicated shapes is that upper part 14a and lower part 14b of steam generating device 14 are separate from each other.

Steam chamber 35, apertured plate 37, and placing table 38 are detachable, and can be removed for cleaning

### Second Exemplary Embodiment

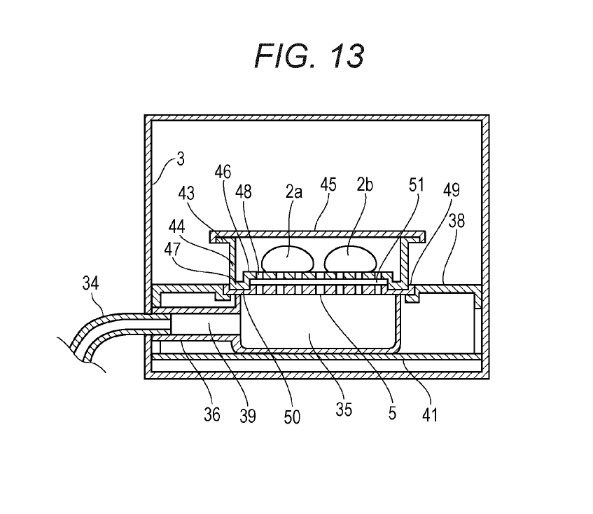

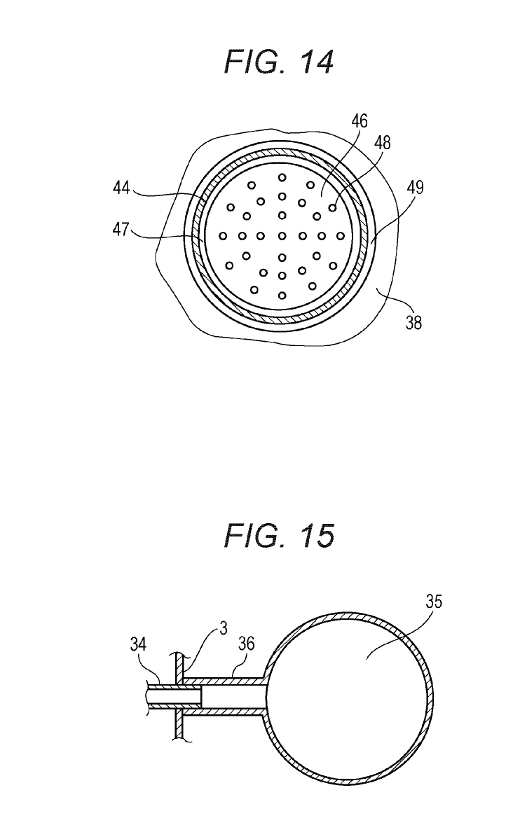

FIG. 13 is a cross-sectional view of a substantial part of a cooker according to a second exemplary embodiment of the present invention. FIG. 14 is a cross-sectional view of a substantial part of a food item container body of the cooker according to the second exemplary embodiment of the present invention viewed from above. FIG. 15 is a cross-sectional view of a substantial part of a steam chamber of the cooker according to the second exemplary embodiment of the present invention viewed from above.

As illustrated in FIGS. 13 to 15, food items 2a and 2b are contained in cooking chamber 3. Steam that has passed through relay tube 34 flows from steam introducing path 36 to cooking chamber 3 and flows to steam chamber 35 located above cooking chamber bottom plate 41 through communicating path 39, and thus the steam is delivered to food items 2a and 2b to be cooked. The steam flowing into steam chamber 35 is ejected through steam ejection openings 5 formed in a surface that is flush with placing table 38 and makes contact with food items 2a and 2b. These constituent elements are identical to those described in the first exemplary embodiment and are given identical reference signs and names, and detailed description of these constituent elements is omitted.

As illustrated in FIG. 13, food items 2a and 2b are heated in a state where food items 2a and 2b are contained in food item container 43. Food item container 43 is constituted by two parts, a lower one of which is food item container body 44 and an upper one of which is food item container lid 45.

Food item container 43 has a circular shape in plan view as illustrated in the cross-sectional view of food item container body 44 in FIG. 14. Container projection 47 is formed along an outer circumference of bottom surface 46 of food item container body 44, and a plurality of holes 48 are formed in bottom surface 46. For example, food items 2a and 2b such as frozen meat buns are contained in advance in food item container 43 (food items 2a and 2b are not illustrated in FIG. 14).

Apertured plate 49 provided at a center of placing table 38 has a plurality of steam ejection openings 5, and apertured plate recess 50 is formed along an outer circumference of apertured plate 49. Container projection 47 and apertured plate recess 50 are shaped so as to be fitted with each other, and gap 51 is formed between bottom surface 46 of food item container body 44 and apertured plate 49 in a state where container projection 47 and apertured plate recess 50 are fitted with each other. Food item container body 44 and food item container lid 45 are made, for example, of a polypropylene resin that can endure a temperature of steam and the like. As illustrated in the cross-sectional view of FIG. 15, steam chamber 35 also has a circular shape in plan view in accordance with the circular shape of food item container 43, and a side surface of steam chamber 35 has steam introducing path 36, which is fitted with relay tube 34.

The operation and effect of the cooker having the above-mentioned configuration are hereinafter described.

An operation of heating food items 2a and 2b is similar to that in the first exemplary embodiment, but steam ejected from steam ejection openings 5 is diffused once in gap 51 formed between bottom surface 46 of food item container body 44 and apertured plate 49. Accordingly, steam can be guided into food item container 43 through holes 48 without influence of a positional deviation between steam ejection openings 5 and holes 48, and thus food item container 43 can be filled with steam. This makes it possible to very effectively heat food items 2a and 2b.

In the present exemplary embodiment, food item container 43 has a circular shape in plan view, and container projection 47 and apertured plate recess 50 are fitted with each other, but the positions in a circumferential direction are not fixed, and therefore positions of steam ejection openings 5 and positions of holes 48 of food item container 43 are easily deviated from each other. However, steam from steam ejection openings 5 can be stably guided into food item container 43 through holes 48 without influence of a positional deviation between the positions of steam ejection openings 5 and the positions of holes 48 of food item container 43 due to the effect of gap 51 as described above.

Furthermore, since the position of food item container 43 is fixed because container projection 47 and apertured plate recess 50 are fitted with each other, it is less likely that heating becomes unstable because of a positional deviation of food item container 43. Furthermore, since leakage of steam from the gap between bottom surface 46 of food item container body 44 and apertured plate 49 can be suppressed because container projection 47 and apertured plate recess 50 are fitted with each other, it is possible to increase heating efficiency. Furthermore, when a volume of steam that fills food item container 43 becomes equal to or larger than a certain volume, steam leaks from a gap between food item container body 44 and food item container lid 45, and thus steam can be smoothly introduced into food item container 43.

Furthermore, although steam introduced into food item container 43 is used for heating of food items 2a and 2b, water that drops, for example, from food items 2a and 2b is drained out of food item container 43 through holes 48. This can make food items 2a and 2b less damp, thereby improving finished quality of food items 2a and 2b. Furthermore, since food item container 43 has a circular shape in plan view, steam that fills food item container 43 can be more easily distributed. This can improve a temperature distribution of food items 2a and 2b. In the present exemplary embodiment, a food item can be heated in a state where the food item is placed in food item container 43. Since a food item can be heated without need to directly touch the food item, application of the present exemplary embodiment to food item heating in industries such as the food service industry provides hygienic food item heating. Furthermore, since the food item can be served to a customer in a state where the food item is contained in food item container 43, convenience improves.

### Third Exemplary Embodiment

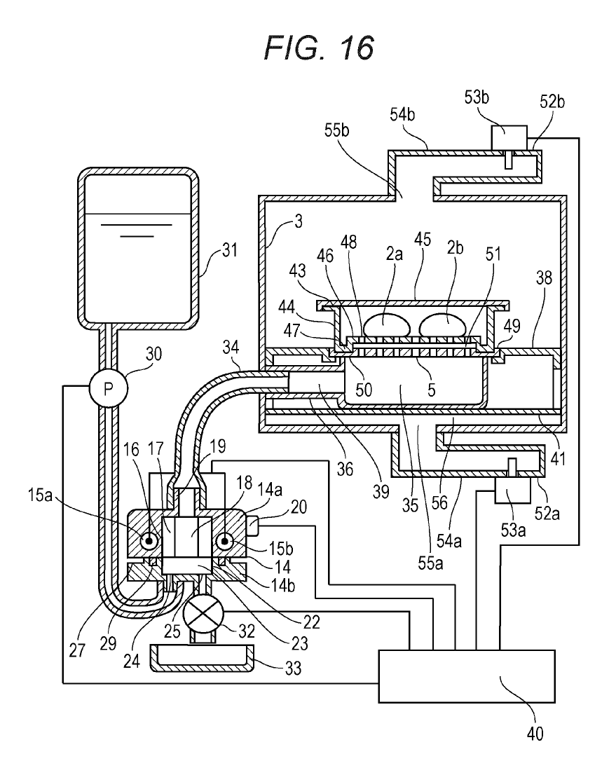

FIG. 16 is a cross-sectional view of an overall configuration of a cooker according to a third exemplary embodiment of the present invention. As illustrated in FIG. 16, water supply device 30 that is an electric pump supplies water from water supply tank 31 to water supply hole 24 of steam generating device 14.

Upper part 14a of steam generating device 14 is made, for example, of die-cast aluminum and includes heat sources 15a and 15b that are sheath heaters, and temperature increasing unit 16 is provided on an inner side of heat sources 15a and 15b. Walls of temperature increasing unit 16 have fin-shaped projections 17. Steam generating chamber 18 is formed by a space surrounded by the walls of temperature increasing unit 16, and steam hole 19 is provided in an upper surface of steam generating chamber 18. Temperature detector 20 is provided on an outer wall side close to temperature increasing unit 16 and detects a temperature of temperature increasing unit 16.

Lower part 14b of steam generating device 14 is made, for example, of die-cast aluminum and forms water storage unit 23 having recess 22. Water supply hole 24 and water drainage hole 25 are provided in a bottom surface of water storage unit 23. An upper surface of lower part 14b of steam generating device 14 has step 27.

Ring-shaped packing 29 that is made, for example, of silicone rubber is provided between upper part 14a and lower part 14b of steam generating device 14. This prevents leakage of steam. Water drainage from water drainage hole 25 that is communicated with water storage unit 23 is controlled by opening and closing of electric drain valve 32. Drained water is received by water drainage tray 33. One end of relay tube 34 that is made, for example, of silicone rubber is attached to steam hole 19, and the other end of relay tube 34 is attached to a side wall of cooking chamber 3.

Furthermore, control device 40 is electrically connected to heat sources 15a and 15b, temperature detector 20, water supply device 30, and drain valve 32 and controls a series of operations.

Food items 2a and 2b such as frozen meat buns are contained in cooking chamber 3. Steam that has passed through relay tube 34 flows from steam introducing path 36 to cooking chamber 3 and flows to steam chamber 35 located above cooking chamber bottom plate 41 through communicating path 39, and thus the steam is delivered to food items 2a and 2b to be cooked. The steam flowing into steam chamber 35 is ejected through steam ejection openings 5 formed in a surface that is flush with placing table 38 and makes contact with food items 2a and 2b.

These constituent elements are identical to those described in the first exemplary embodiment and are given identical reference signs and names.

Food items 2a and 2b are heated in a state where food items 2a and 2b are contained in food item container 43. Food item container 43 is constituted by two parts, a lower one of which is food item container body 44 and an upper one of which is food item container lid 45. Container projection 47 is formed along an outer circumference of bottom surface 46 of food item container body 44, and a plurality of holes 48 are formed in bottom surface 46.

Apertured plate 49 provided at a center of placing table 38 has a plurality of steam ejection openings 5, and apertured plate recess 50 is formed along an outer circumference of apertured plate 49. Container projection 47 and apertured plate recess 50 are shaped so as to be fitted with each other, and gap 51 is formed between bottom surface 46 of food item container body 44 and apertured plate 49 in a state where container projection 47 and apertured plate recess 50 are fitted with each other.

These constituent elements are identical to those described in the second exemplary embodiment and are given identical reference signs and names.

Microwave generating device 52a is provided in a lower part of cooking chamber 3, and microwave generating device 52b is provided is an upper part of cooking chamber 3. Microwave generating device 52a is configured such that magnetron 53a that generates a microwave is attached to wave guide 54a, and an opened end of wave guide 54a is fixed to communicating hole 55a of cooking chamber 3. Thus, a microwave generated by magnetron 53a is guided into cooking chamber 3 by wave guide 54a. Space 56 between cooking chamber bottom plate 41 and cooking chamber 3 is communicated with communicating hole 55a. Furthermore, cooking chamber bottom plate 41 is made of a material, such as crystallized glass, that has good microwave transmissivity and therefore poses no problem in transmission of a microwave into cooking chamber 3.

Microwave generating device 52b is configured such that magnetron 53b that generates a microwave is attached to wave guide 54b, and an opened end of wave guide 54b is fixed to communicating hole 55b of cooking chamber 3. Thus, a microwave generated by magnetron 53b is guided into cooking chamber 3 by wave guide 54b.

An antenna that improves a microwave distribution and the like by changing a state of introduction of a microwave into cooking chamber 3 may be provided close to communicating holes 55a and 55b although the antenna is not described as a constituent element of the present exemplary embodiment. Magnetrons 53a and 53b are electrically connected to control device 40, and a microwave generated by magnetrons 53a and 53b is controlled by control device 40. Steam chamber 35, apertured plate 49, placing table 38, food item container body 44, and food item container lid 45 are made, for example, of a polypropylene resin, which has heat resistance to steam and is hard to absorb a microwave, and therefore food items 2a and 2b can be efficiently heated by a microwave.

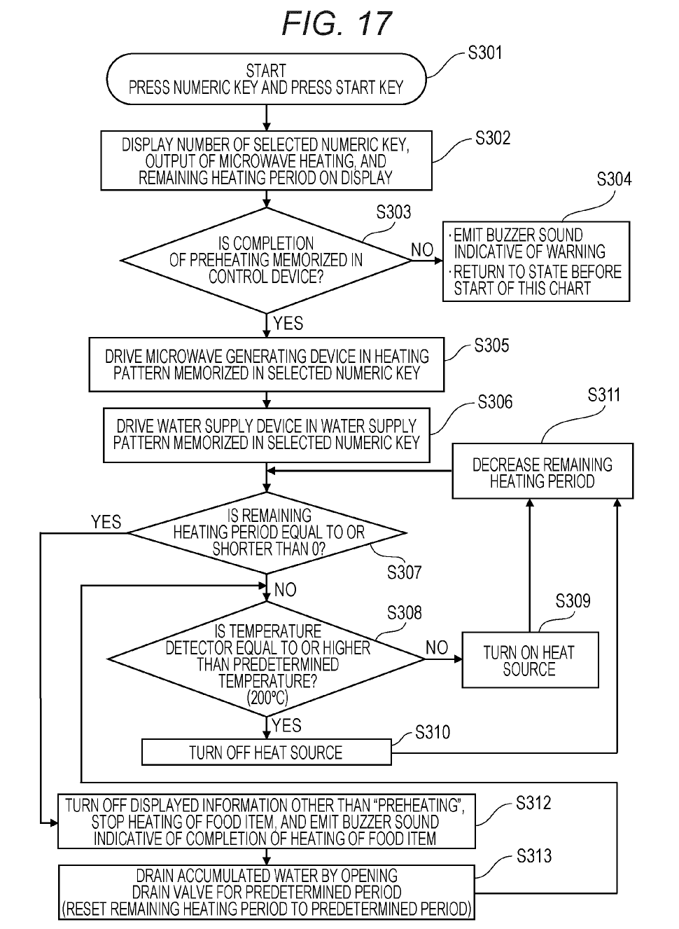

Hereinafter, the manner of operation and effects of the cooker having the above-mentioned configuration will be described with reference to the flowchart in FIG. 17.

An operation of preheating a temperature of temperature increasing unit 16 of steam generating device 14 to a predetermined temperature (set to 200° C. in the present exemplary embodiment) is similar to that in the first exemplary embodiment. Specifically, the preheating operation is performed by pressing preheating key 7 of operation unit 4, as illustrated in FIG. 8. In this state, a door (not illustrated) of cooking chamber 3 is opened, and food item container 43 in which food items 2a and 2b such as frozen meat buns are contained in advance is placed in a state where container projection 47 of food item container body 44 and apertured plate recess 50 of apertured plate 49 are fitted with each other as illustrated in FIG. 16. Food items 2a and 2b are heated by pressing numeric key 11 memorizing in advance a heating pattern suitable for heating of food item container 43 in which food items 2a and 2b are contained and then pressing start key 6 (step S301 of FIG. 17).

In the present exemplary embodiment, food item container 43 in which food items 2a and 2b that are frozen meat buns are contained is also heated by a microwave, and therefore numeric key 11 given a number “2” memorizing a heating pattern suitable for this heating is pressed. This heating is performed on the assumption that preheating of temperature increasing unit 16 has been completed. For this reason, in a case where preheating has not been completed, i.e., in a case where completion of preheating is not memorized in control device 40 (step S303), the operation does not proceed even if start key 6 is pressed, and buzzer sound indicative of warning is issued to alert a user (step S304). In a case where a user wants to memorize a heating pattern in numeric key 11 in advance, the heating pattern is memorized according to a predetermined algorithm by using memory key 12, output key 9, water supply key 10, numeric key 11, and the like.

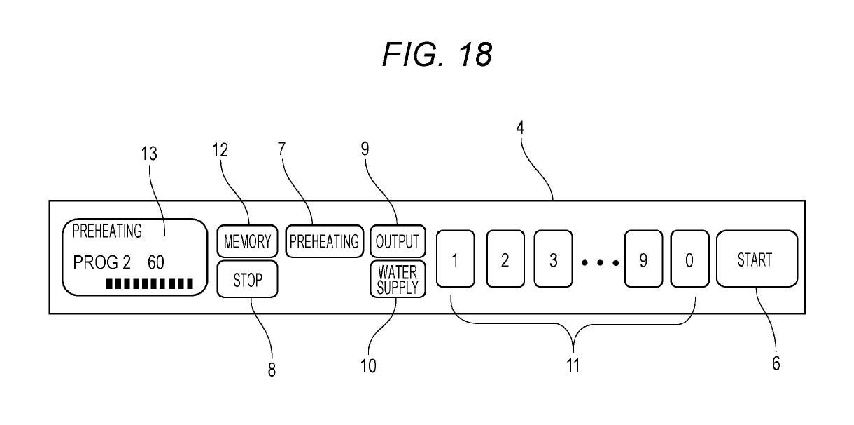

In a state where preheating of temperature increasing unit 16 of steam generating device 14 has been completed, numeric key 11 (number “2” in the present exemplary embodiment) for a heating pattern suitable for food item container 43 in which food items 2a and 2b that are frozen meat buns are contained is pressed as described above, and start key 6 is pressed (step S301). As a result, “PROG 2” indicative of which heating pattern is being used, “60” indicative of remaining seconds of heating, and a “level meter” of output of microwave heating are displayed on display 13 as illustrated in FIG. 18 (step S302).

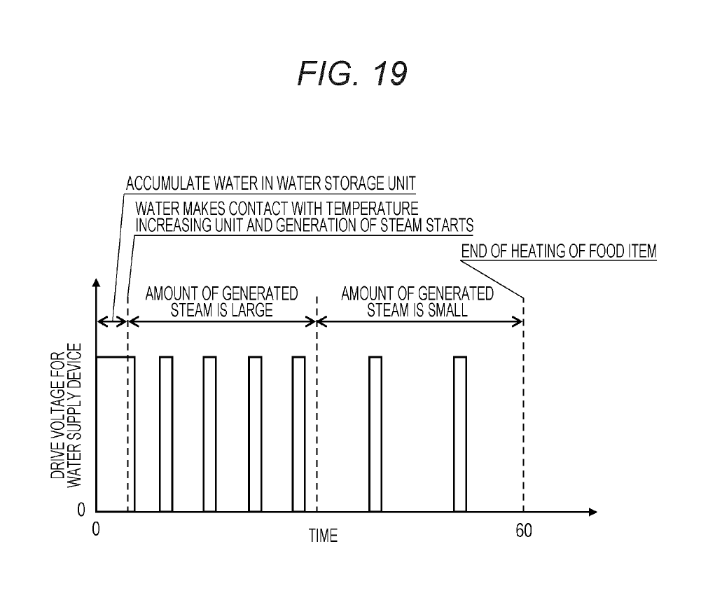

In the present exemplary embodiment, for example, microwave output of 1800 W is expressed by 10 dots as “level meter” on display 13. Concurrently, water supply device 30 is operated in a water supply pattern (see FIG. 19) corresponding to this heating pattern, and thus water is delivered from water supply tank 31 to water storage unit 23 through water supply hole 24 (step S306).

In this water supply, an amount of water to be stored in water storage unit 23 is first supplied. When water contacts with temperature increasing unit 16 and generation of steam starts, a predetermined amount of water (an amount of water is controlled by repetition of ON and OFF of water supply device 30 in the present exemplary embodiment) is supplied, and thus steam can be stably supplied. In an initial stage of steam generation, an amount of supply water is increased by shortening a water supply interval, and after a short while, the amount of supply water is decreased by prolonging the water supply interval. In this way, a volume of steam is increased in an initial stage of heating, and the volume of steam is decreased from a middle stage to a final stage of heating.

Accordingly, delivered water is accumulated in recess 22 of water storage unit 23, and a water level gradually rises. When water contacts with temperature increasing unit 16, the water instantaneously turns into steam since temperature increasing unit 16 is preheated to a predetermined temperature (approximately 200° C.). Furthermore, a large volume of steam is generated in the initial stage of heating so that steam generating chamber 18 is filled with steam, and steam that bursts out of steam ejection openings 5 from steam hole 19 through relay tube 34 and steam chamber 35 by a pressure of the accumulated steam makes contact with food items 2a and 2b. In this way, a large volume of heat accumulated in temperature increasing unit 16 by preheating is transmitted to steam, and thus the large volume of heat can be transmitted to food items 2a and 2b. This makes it possible to promote heating of food items 2a and 2b at once. Water that drops, for example, from food items 2a and 2b is drained to steam chamber 35 through steam ejection openings 5. This can make food items 2a and 2b less damp, thereby improving a finished state of food items 2a and 2b.

Furthermore, this large volume of steam promotes thawing of food items 2a and 2b that are still frozen in the initial stage of heating, thereby markedly accelerating heating. Magnetrons 53a and 53b of microwave generating devices 52a and 52b are driven by control device 40 (step S305) so as to output a microwave in cooking chamber 3. This can further accelerate thawing and heating of food items 2a and 2b. Although ice heating performance of a microwave is inferior to water heating performance, dew condensation water is instantaneously generated in a superficial part of food items 2a and 2b when steam makes contact with frozen food items 2a and 2b, and a microwave efficiently acts on and heats the dew condensation water. This can markedly improve performance for heating frozen food items 2a and 2b.

Furthermore, in a case where food item container 43 is filled with steam, a dielectric constant of the space changes, and a wavelength of a microwave in food item container 43 becomes short. This lessens heating unevenness. That is, addition of heating using a microwave to heating using steam markedly improves heating performance.

Furthermore, since heating using a microwave is also performed in this state, food items 2a and 2b that have been thawed can be heated by steam and a microwave. This can improve a finished state of steamed food items 2a and 2b and shorten a heating time. A reason why the finished state improves is that moisture applied to food items 2a and 2b in a large volume to improve thawing performance in the initial stage of heating evaporates and decreases by heating using a microwave, and as a result dampness of the superficial part of food items 2a and 2b can be prevented.

The remaining heating time (“60” in FIG. 18) displayed on display 13 decreases with passage of a heating time (steps 5307 to S311), and the user is notified of completion of heating of food items 2a and 2b when the displayed remaining heating time becomes “0” (step S307). As a method for notifying the user, “PROG 2”, the remaining heating time, and “level meter” of output of microwave heating are turned off, and buzzer sound indicative of completion of heating of food items 2a and 2b is emitted (step S312).

Even after completion of food item heating, temperature increasing unit 16 of steam generating device 14 keeps preheating at the predetermined temperature (approximately 200° C.) by resetting the remaining heating time to a predetermined period (a period for which preheating is continued) (step S313) as illustrated in the flowchart of FIG. 17 and thus prepares for heating of a next food item. In a case where the user wants to finish preheating, the user presses preheating key 7 of operation unit 4 and presses the stop key promptly (within two seconds). As a result, the text “preheating” on display 13 disappears, and preheating can be stopped.

As described above, when heating of food items 2a and 2b ends, control device 40 opens drain valve 32, and thus water accumulated in water storage unit 23 during heating is drained (step S313). As illustrated in the flowchart of FIG. 17, drain valve 32 is opened only for a predetermined period after the end of heating of food items 2a and 2b, and drain valve 32 is closed for a period other than the predetermined period. In a case where used water contains a scale component, the scale component is condensed in accumulated water. By draining the accumulated water, it is possible to suppress accumulation of a scale in steam generating device 14.

In the present exemplary embodiment, top surfaces of placing table 38 and apertured plate 49 are substantially flat, and therefore the cooker can be also used for warming of a food item by using a microwave only in a state where a food item such as a box lunch is placed on placing table 38 and apertured plate 49, like a general microwave oven. This is very convenient. Furthermore, since microwave heating is used, a food item that is different from food items 2a and 2b put in food item container 43, which are heated by steam and a microwave, can be heated in a container different from food item container 43 by using only a microwave.

For example, another food item put in a container different from food item container 43 may be placed on food item container 43 and be heated by using a microwave. In this way, the other food item can be heated concurrently with food items 2a and 2b. For example, a meat bun and Chinese soup can be heated concurrently. Since not only a food item put into food item container 43, but also a food material, source, or the like that is eaten together with the food item can be heated concurrently, convenience improves.

Furthermore, steam chamber 35, placing table 38, and apertured plate 49 are detachable, and can be removed for cleaning Furthermore, steam chamber 35, placing table 38, and apertured plate 49 can be detached from cooking chamber 3 so that a height of cooking chamber 3 is increased. In this way, a tall food item can be heated by using only a microwave like a general microwave oven.

In the present exemplary embodiment, a microwave generating device is provided in the upper part and the lower part of cooking chamber 3, but a microwave generating device may be provided in either the upper part or the lower part. Furthermore, food items 2a and 2b may be directly placed on apertured plate 49 and heated without use of food item container 43 as in the first exemplary embodiment.

In the first to third exemplary embodiments, temperature increasing unit 16 is preheated to the predetermined temperature, and then water is supplied to water storage unit 23, so that the water instantaneously evaporates. However, temperature increasing unit 16 may be heated by heat sources 15a and 15b concurrently with water supply to water storage unit 23. That is, steam may be generated by gradually supplying water while increasing the temperature of temperature increasing unit 16. There are various operation algorithms for generation of steam, and an algorithm suitable for heating of a food item need just be used.

In the first to third exemplary embodiments, recess 22 of water storage unit 23 has a shape of a rectangular parallelepiped having a flat bottom surface. However, the bottom surface of recess 22 may be inclined, and water drainage hole 25 may be provided in a bottommost part of the inclined bottom surface. In this way, water accumulated in recess 22 can be fully drained. In a case where water supply is stable, it takes a shorter time to generate steam as recess 22 becomes shallower. An experiment and the like revealed that approximately 1 mm to 2 mm is enough as a depth of recess 22.

In the first to third exemplary embodiments, two frozen meat buns are used as food items 2a and 2b. However, a state of a food item may be a frozen state or may be a cooled state, and the number of food items and kinds (e.g., noodles and rice) of food items are not limited in particular. In a case where a food item such as noodles or rice that is easy to separate is used, use of food item container 43 in the second and third exemplary embodiments makes handling easier and thereby improves convenience. Furthermore, since food item container 43 has a circular shape in plan view, a whole shape of a food item such as noodles or rice that is put into food item container 43 and is heated by using a microwave (see the third exemplary embodiment) becomes circular. Since there is no corner where a microwave is likely to concentrate, it is possible to improve a distribution of heating.

In the first to third exemplary embodiments, steam ejection openings 5 are provided below food items 2a and 2b. Alternatively, steam ejection openings 5 may be provided, for example, above food items 2a and 2b. In short, it is only necessary that steam makes contact with food items 2a and 2b.

In the second and third exemplary embodiments, food item container 43 has a circular shape in plan view, but the shape of food item container 43 is not limited to this. For example, food item container may have an oval shape or a rectangular shape in plan view. In the second and third exemplary embodiments, a container is used to contain a food item. However, anything (e.g., a bag) in which a food item can be contained can be used. In short, anything for packing a food item or the like can be used, as long as holes are formed. Furthermore, a material of a package for containing a food item is not limited to a resin and can be any material, such as paper or rubber, that can endure heat of steam.

In the second and third exemplary embodiments, holes 48 of food item container 43 are provided only in bottom surface 46, but holes 48 may be provided at any positions of food item container 43 as long as steam from steam ejection openings 5 can be introduced.

In the first to third exemplary embodiments, relay tube 34 and steam chamber 35 constitute communicating path 39, and steam is delivered from steam generating device 14 to steam ejection openings 5 through communicating path 39. However, the configuration of the communicating path is not limited to the above configuration. For example, the communicating path may be constituted only by a relay tube. In short, it is only necessary that a continuous path from steam generating device 14 to steam ejection openings 5 be constituted by one or more components so that steam can be delivered.

In the first to third exemplary embodiments, an amount of water supply per unit time is adjusted by changing an ON/OFF cycle of a drive voltage for water supply device 30 that is an electric pump. However, for example, an amount of water supply per unit time may be adjusted by switching the drive voltage for the electric pump between high and low.

In the first to third exemplary embodiments, control device 40 drains water accumulated in water storage unit 23 by opening drain valve 32 for a predetermined period after end of heating of food items 2a and 2b. However, water may be drained by opening drain valve 32 for a predetermined period during heating of food items 2a and 2b. In short, it is only necessary that water accumulated in water storage unit 23 can be drained.

As described above, the cooker according to the present invention includes a steam generating device that supplies steam to a cooker, a water supply device that supplies water to the steam generating device, and a control device that controls at least the steam generating device and water supply device. The steam generating device includes a temperature increasing unit that turns water into steam, a heat source that supplies heat to the temperature increasing unit, and a water storage unit that has a recess below the temperature increasing unit. Furthermore, steam is generated by contact of the water stored in the water storage unit with the temperature increasing unit.

According to this configuration, steam can be speedily generated since steam is instantaneously generated when the water in the water storage unit makes contact with the temperature increasing unit. Furthermore, even in a case where water in the water storage unit contains a scale component, only water that makes contact with the temperature increasing unit, i.e., only topmost water evaporates. Accordingly, when a scale is generated during evaporation, the scale component dissolves into water that is not directly involved in evaporation. As a result, it is possible to lessen precipitation and adhesion of a scale on the steam generating device.

The present invention may be configured to further include a drain valve in a lower part of the water storage unit, and the control device may drain water from the water storage unit by opening the drain valve after end of heating. According to this configuration, water in the water storage unit in which a concentration of a scale component has increased can be drained.

The present invention may be configured such that the temperature increasing unit and the water storage unit are separate members, and a gap between the temperature increasing unit and the water storage unit is hermetically sealed by packing According to this configuration, the gap between the temperature increasing unit and the water storage unit cam be sealed, and heat of the temperature increasing unit is harder to transmit to the water storage unit since the temperature increasing unit and the water storage unit are separate from each other. This keeps a rise in temperature of the water storage unit small, thereby making it possible to prevent a situation where water is heated and steam is generated just because water is supplied to the water storage unit.

The cooker according to the present invention may be configured to further include a temperature detector that detects a temperature of the temperature increasing unit or the heat source, and the control device may perform preheating so that the temperature of the temperature increasing unit becomes a predetermined temperature, supplies water from the water supply device to the water storage unit after completion of the preheating, and generates steam while keeping a state where a water surface contacts with the temperature increasing unit. According to this configuration, steam can be instantaneously generated, and steam generation can be made stable.

The cooker according to the present invention may be configured such that a food item is contained in a food item container having a hole, the food item container and the steam generating device are communicated with each other, and the food item in the food item container is heated. According to this configuration, heat can be efficiently transmitted to the food item in the food item container when steam is supplied through the hole of the food item container, and a user who performs the heating operation can hold the food item container without directly touching the food item with a hand. This achieves an improvement from hygienic and operational points of view.

The cooker according to the present invention may be configured to further include a cooking chamber provided in a body of the cooker; and a microwave generating device that introduces a microwave into the cooking chamber, the cooking chamber and the steam generating device may be communicated with each other, and the control device may heat a food item in the cooking chamber by using the microwave generating device and the steam generating device. According to this configuration, steam and a microwave are used as means for heating a food item. This further shortens a period necessary for a rise in temperature of the food item. In a case where the food item is a frozen food item, a microwave has good efficiency of heating of water but has poor efficiency of heating of ice. However, steam acts on a frozen surface of the frozen food item so as to thaw the surface of the frozen food item instantly. When moisture is present on the surface of the food item, a microwave efficiently heats the water. In this way, heating of the food item can be promoted.

### INDUSTRIAL APPLICABILITY

As described above, a cooker of the present invention can speedily heat a frozen food item or the like having a large heating load by using steam and is therefore applicable, for example, to a heating step in a food factory.

### REFERENCE MARKS IN THE DRAWINGS

1; body

2a, 2b: food item

3: cooking chamber

4: operation unit

5: steam ejection opening

6: start key

7: preheating key

8: stop key

9: output key

10: water supply key

11: numeric key

12: memory key

13: display

14: steam generating device

15a, 15b: heat source

16: temperature increasing unit

20: temperature detector

22: recess

23: water storage unit

24: water supply hole

25: water drainage hole

26: packing groove

27: step

28: through hole

29: packing

30: water supply device

31: water supply tank

32: drain valve

33: drain tray

34: relay tube

35: steam chamber

36: steam introducing path

37: apertured plate

38: placing table

39: communicating path

40: control device

41: cooking chamber bottom plate

43: food item container

44: food item container body

45: food item container lid

46: bottom surface

47: container projection

48: hole

49: apertured plate

50: apertured plate recess

51: gap

52a, 52b: microwave generating device

53a, 53b: magnetron

54a, 54b: wave guide

55a, 55b: communicating hole

56: space

1. A cooker comprising:
a steam generating device that supplies steam to the cooker;
a water supply device that supplies water to the steam generating device; and
a control device that controls at least the steam generating device and the water supply device, wherein the steam generating device includes:
a temperature increasing unit that turns water into steam, a heat source that supplies heat to the temperature increasing unit, and a water storage unit that has a recess below the temperature increasing unit, and wherein steam is generated by contact of water stored in the water storage unit with the temperature increasing unit.

2. The cooker according to claim 1, further comprising
a drain valve in a lower part of the water storage unit, wherein the control device drains water from the water storage unit by opening the drain valve after end of heating.

3. The cooker according to claim 1, wherein the temperature increasing unit and the water storage unit are separate members, and a gap between the temperature increasing unit and the water storage unit is hermetically sealed by packing.

4. The cooker according to claim 2, wherein the temperature increasing unit and the water storage unit are separate members, and a gap between the temperature increasing unit and the water storage unit is hermetically sealed by packing.

5. The cooker according to claim 1, further comprising
a temperature detector that detects a temperature of the temperature increasing unit or the heat source, wherein the control device performs preheating so that the temperature of the temperature increasing unit becomes a predetermined temperature, supplies water from the water supply device to the water storage unit after completion of the preheating, and generates steam while keeping a state where a water surface contacts with the temperature increasing unit.

6. The heater according to claim 1, wherein a food item is contained in a food item container having a hole, the food item container and the steam generating device are communicated with each other, and the food item in the food item container is heated.

7. The heater according to claim 5, wherein a food item is contained in a food item container having a hole, the food item container and the steam generating device are communicated with each other, and the food item in the food item container is heated.

8. The cooker according to claim 1, further comprising:
a cooking chamber provided in a body of the cooker; and
a microwave generating device that introduces a microwave into the cooking chamber, wherein the cooking chamber and the steam generating device are communicated with each other, and wherein the control device heats a food item in the cooking chamber by using the microwave generating device and the steam generating device.

9. The cooker according to claim 5, further comprising:
a cooking chamber provided in a body of the cooker; and
a microwave generating device that introduces a microwave into the cooking chamber, wherein the cooking chamber and the steam generating device are communicated with each other; and
wherein the control device heats a food item in the cooking chamber by using the microwave generating device and the steam generating device.

10. The cooker according to claim 6, further comprising:
a cooking chamber provided in a body of the cooker; and
a microwave generating device that introduces a microwave into the cooking chamber, wherein the cooking chamber and the steam generating device are communicated with each other, and wherein the control device heats a food item in the cooking chamber by using the microwave generating device and the steam generating device.

11. The cooker according to claim 7, further comprising:
a cooking chamber provided in a body of the cooker; and
a microwave generating device that introduces a microwave into the cooking chamber, wherein the cooking chamber and the steam generating device are communicated with each other, and wherein the control device heats a food item in the cooking chamber by using the microwave generating device and the steam generating device.
